(19) United States
(12) Patent Application Publication
(10) Pub. No.: US 2025/0192685 A1
(43) Pub. Date: Jun. 12, 2025

(54) BAIS VOLTAGE GENERATOR, POWER CONVERTER, AND BAIS VOLTAGE GENERATING METHOD

(71) Applicant: Richtek Technology Corporation, Zhubei City (TW)

(72) Inventor: Tzu-Chen LIN, Zhubei City (TW)

(21) Appl. No.: 18/419,739

(22) Filed: Jan. 23, 2024

(30) Foreign Application Priority Data
Dec. 6, 2023 (TW) 112147343

(51) Int. Cl. H02M 3/335; H02M 1/088; H02M 3/00

(52) U.S. Cl. CPC H02M 3/33571; H02M 1/088; H02M 3/01; H02M 3/33576

(57) ABSTRACT

A bias voltage generator includes an auxiliary winding, a switch circuit, an inductor, a diode, and a capacitor. The switch circuit is coupled to the auxiliary winding at a first node and controlled by a control signal. The inductor is coupled to the switch circuit at a second node and to a ground. The diode is coupled between the second node and a voltage output terminal. The capacitor is coupled between the voltage output terminal and the ground. In response to that the switch circuit is turned on, the inductor is charged by a charge current flowing the switch circuit and the auxiliary winding. In response to that the switch circuit is turned off, the inductor is discharged through a charge current flowing the diode and the capacitor. An output voltage is generated at the voltage output terminal. The second output voltage changes according to the control signal.

### CROSS REFERENCE TO RELATED APPLICATIONS

This Application claims priority of Taiwan Patent Application No. 112147343 filed on Dec. 6, 2023, the entirety of which is incorporated by reference herein.

### BACKGROUND OF THE INVENTION

### Field of the Invention

The present invention relates to a bias voltage generator, in particular to a bias voltage generator for a power converter, which generates a supply voltage provided to a primary-side controller.

### Description of the Related Art

Generally, in an offline power converter, a bias circuit coupled to an auxiliary winding of the power converter provides a bias voltage to power a controller located on the primary side of the power converter. Since the auxiliary winding is part of a transformer of the power converter, the bias voltage is proportional to an output voltage of the power converter. For an application with a wide range of the output voltage, the bias voltage will become greater as the change in the output voltage. However, the primary-side controller has a low withstand voltage. Therefore, in an application with a wide range of output voltage, the primary-side controller may be damaged due to the greater bias voltage.

### BRIEF SUMMARY OF THE INVENTION

The present invention provides an exemplary embodiment of a bias voltage generator for a power converter. The power converter comprises a transformer. The bias voltage generator comprises an auxiliary winding, a switch circuit, an inductor, a first diode, and a capacitor. The switch circuit is coupled to the auxiliary winding at a first node and controlled by a control signal. The inductor comprises a first terminal coupled to the switch circuit at a second node and a second terminal coupled to a ground. The first diode comprises an anode coupled to the second node and a cathode coupled to a voltage output terminal. The capacitor is coupled between the voltage output terminal and the ground. In response to that the switch circuit is turned on, the inductor is charged by a charging current flowing through the switch circuit and the auxiliary winding. In response to that the switch circuit is turned off, the inductor is discharged through a discharge current flowing through the first diode and the capacitor. An output voltage is generated at the voltage output terminal, and the output voltage changes according to the control signal.

The present invention provides an exemplary embodiment of a power converter. The power converter comprises a transformer, a primary-side circuit, a secondary-side circuit, a controller, and a bias voltage generating circuit. The transformer comprises a primary winding, a secondary winding, and an auxiliary winding. The auxiliary winding comprises a first terminal and a second terminal. The primary-side circuit is coupled to the primary winding and receives an input voltage and a driving signal. The primary-side circuit comprises a first switch coupled to the primary winding. The first switch is controlled by the driving signal to convert the input voltage to energy, and the energy is stored in the transformer. The secondary-side circuit is coupled to the secondary winding and generates a first output voltage at a first voltage output terminal according to the energy stored in the transformer. The controller generates the driving signal according to the first output voltage and further generates a control signal. The bias voltage generating circuit is coupled to the first terminal and the second terminal of the auxiliary winding and controlled by the control signal to generate a second output voltage at a second voltage output terminal according to the energy stored in the transformer. The bias voltage generating circuit adjusts the second output voltage according to the control signal. The second output voltage is provided to the controller as a supply voltage of the controller. The bias voltage generator comprises a switch circuit, an inductor, a first diode, and a capacitor. The switch circuit is coupled to the first terminal of the auxiliary winding at a first node and controlled by the control signal. The inductor comprises a first terminal coupled to the switch circuit at a second node and a second terminal coupled to a ground. The first diode comprises an anode coupled to the second node and a cathode coupled to the second voltage output terminal. The capacitor is coupled between the second voltage output terminal and the ground. In response to that the first switch and the switch circuit are turned on at the same time, the inductor is charged by a charging current flowing through the switch circuit and the auxiliary winding. In response to that the switch circuit is turned off, the inductor is discharged through a discharge current flowing through the first diode and the capacitor.

The present invention provides an exemplary embodiment of a bias voltage generating method. A bias voltage generating method is provided for a power converter. The power converter comprises a transformer, a primary-side circuit, a controller, and a bias voltage generating circuit. The transformer comprises a primary winding and an auxiliary winding. The primary-side circuit is coupled to the primary winding. The controller comprises a first switch. The bias voltage generating circuit is coupled to the auxiliary winding. The bias voltage generating circuit comprises a switch circuit, an inductor, a first diode, and a capacitor. The bias voltage generating method comprises steps of: by the controller, generating a driving signal to control the first switch and further generating a control signal to control the switch circuit; by the primary-side circuit, converting an input voltage to energy according to the driving signal, wherein the energy is stored in the transformer; generating an output voltage by charging and discharging the inductor; providing the output voltage to the controller as a supply voltage of the controller; and changing the control signal according to the input voltage or the output voltage, thereby adjusting the output voltage. The step of generating an output voltage by charging and discharging the inductor comprises: through the driving signal and the control signal, turning on the first switch and the switch circuit at the same time to generate a charging current flowing through the switch circuit and the auxiliary winding according to the energy stored in the transformer to charge the inductor; and through the control signal, turning off the switch circuit to generate a discharge current flowing through the first diode and the capacitor to discharge the inductor.

### BRIEF DESCRIPTION OF THE DRAWINGS

The present invention can be more fully understood by reading the subsequent detailed description and examples with references made to the accompanying drawings, wherein:

FIG. 1 shows one exemplary embodiment of a power converter;

FIG. 2 is a diagram showing waveforms of main signals diagrams of a power converter according to an exemplary of the present invention.

FIG. 3 shows another exemplary embodiment of a power converter;

FIG. 4 shows another exemplary embodiment of a power converter;

FIG. 5 shows another exemplary embodiment of a power converter; and

FIG. 6 shows another exemplary embodiment of a power converter.

### DETAILED DESCRIPTION OF THE INVENTION

The following description is made for the purpose of illustrating the general principles of the invention and should not be taken in a limiting sense. The scope of the invention is best determined by reference to the appended claims.

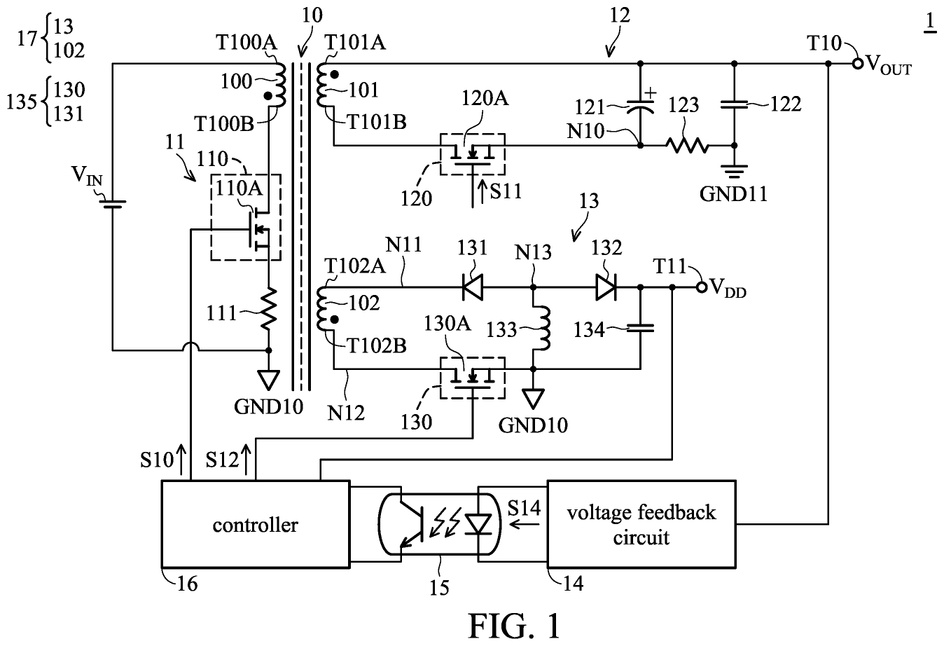

FIG. 1 shows one exemplary embodiment of a power supply. Referring to FIG. 1, a power converter 1 comprises a transformer 10, a primary-side circuit 11, a secondary-side circuit 12, a bias voltage generating circuit 13, a voltage feedback circuit 14, an optical coupler 15, and a controller 16. The transformer 10 comprises a primary winding 100, a secondary winding 101, and an auxiliary winding 102. In the embodiment, the auxiliary winding 102 is coupled to the bias voltage generating circuit 13 to form a bias voltage generator 17.

The power converter 1 provided in the embodiment can be any type of power converter comprising a transformer. For example, in the embodiment of FIG. 1, according to the circuit structure of the transformer 10, the primary-side circuit 11, and the secondary-side circuit 12, the power converter 1 is a flyback power converter. Referring to FIG. 1, the primary winding 100 comprises a first terminal T100A and a second terminal T100B, and the secondary winding 101 comprises a first terminal T101A and a second terminal T101B. The first terminal T100A of the primary winding 100 and the second terminal T101B of the secondary winding 101 are the terminals with the same polarity (that is, the terminals with the same name), and the second terminal T100B of the primary winding 100 and the first terminal of T101A of the secondary winding 101 are terminals with the same polarity.

As shown in FIG. 1, the primary-side circuit 11 comprises a power switch 110 and a resistor 111. The on/off state of the power switch 110 is controlled by a driving signal S10. The first terminal T100A of the primary winding 100 receives an input voltage V_{IN}. An input terminal of the power switch 110 is coupled to the second terminal T100B of the primary winding 100, and a control terminal thereof receives the driving signal S10. The resistor 111 is coupled between an output terminal of the power switch 110 and a ground GND10. The ground GND10 serves as a primary-side ground of power converter 1. The primary-side circuit 11 is controlled by the driving signal S10 to convert the input voltage V_{IN} into energy. The energy that is obtained by converting the input voltage V_{IN} by the primary-side circuit 11 is stored in the transformer 10. In the embodiment, the power switch 110 is implemented by an N-type transistor 110A (for example, an N-type metal oxide semiconductor (NMOS) transistor). The input terminal, control terminal, and output terminal of the power switch 110 correspond to a drain, a gate, and a source of the NMOS transistor 110A respectively.

The secondary-side circuit 12 comprises a switch 120, capacitors 121 and 122, and a resistor 123. The on/off state of the switch 120 is controlled by a driving signal S11. Referring to FIG. 1, the first terminal T101A of the secondary winding 101 is coupled to a voltage output terminal T10 of the secondary-side circuit 12. An input terminal of the switch 120 is coupled to the second terminal T101B of the secondary winding 101, an output terminal thereof is coupled to a node N10, and a control terminal thereof receives the driving signal 511. The capacitor 121 is coupled between the voltage output terminal T10 and the node N10. The resistor 123 is coupled between the node N10 and a ground GND11. The ground GND11 serves as a secondary-side ground of the power converter. The capacitor 122 is coupled between the voltage output terminal T10 and the ground GND11. The ground GND10 and the ground GND11 are electrically isolated from each other, that is, there is no resistive current path between the ground GND10 and the ground GND11. In the embodiment, the secondary-side circuit 12 is controlled by the driving signal S11 and generates an output voltage V_{OUT} at the voltage output terminal T10 according to the energy stored in the transformer 10. In the embodiment, the switch 120 is implemented by an N-type transistor 120A (for example, an NNMOS transistor). The input terminal, the control terminal, and the output terminal of the switch 120 correspond to a drain, a gate, and a source of the NMOS transistor 120A respectively.

The voltage feedback circuit 14 is coupled to the voltage output terminal T10 and generates a feedback signal S14 according to the output voltage V_{OUT}. The optical coupler 15 transmits the feedback signal S14 to the controller 16 from the secondary side of the transformer 10. The controller 16 generates the driving signal S10. In the embodiment, the driving signal S10 is a pulse-width modulation (PWM) signal. The driving signal S10 comprises a plurality of pulses, and the width of each of the plurality of pulses is variable. That is, the length (that is, the duty cycle) of the pulse period of each pulse of the driving signal S10 in time is variable. The controller 16 changes the width of each of the plurality of pulses of the driving signal S10 (that is, the controller changes the length of the pulse period of each of the plurality of pulses) according to the feedback signal S14 indicating the output voltage V_{OUT}.

Referring to FIG. 1, the bias voltage generating circuit 13 comprises a switch 130, diodes 131 and 132, an inductor 133, and a capacitor 134. The switch 130 and the diode 131 form a switch circuit 135. The on/off state of the switch 130 is controlled by a control signal 512. The auxiliary winding 102 comprises a first terminal T102A and a second terminal T102B which are coupled to nodes N11 and N12 respectively. A cathode of the diode 131 is coupled to the node N11, and an anode thereof is coupled to a node N13. An input terminal of the switch 130 is coupled to the node N12, an output terminal thereof is coupled to the ground GND10, and a control terminal thereof receives the control signal 512. The inductor 133 is coupled between the node N13 and the ground GND10. An anode of the diode 132 is coupled to the node N13, and a cathode thereof is coupled to a voltage output terminal T11 of the bias voltage generating circuit 13. The capacitor 134 is coupled between the voltage output terminal T11 and the ground GND10. The bias voltage generating circuit 13 generates an output voltage V_{DD} at the voltage output terminal T11 by charging and discharging the inductor 133. The output voltage V_{DD} is provided to the controller 16 as a supply voltage of the controller 16. In the embodiment, the switch 130 is implemented by an N-type transistor 130A (for example, an NNMOS transistor). The input terminal, the control terminal, and the output terminal of the switch 130 correspond to a drain, a gate, and a source of the NMOS transistor 130A respectively.

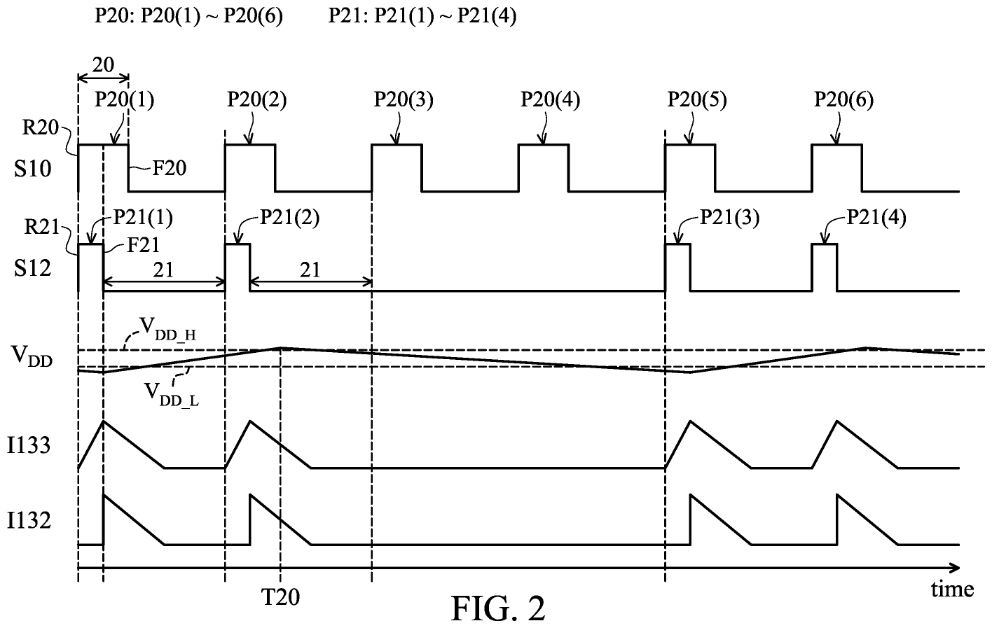

According to the above description, the controller 16 generates the driving signal S10. Moreover, the controller 16 further generates the control signal S12. Referring to FIG. 2, the driving signal S10 comprises a plurality of pulses P20 (as shown in FIG. 2, the plurality of pulses P20 comprise, for example, six pulses P20(1)-P20(6)), and each pulse P20 has an enabling transition edge (that is, a rising edge) R20 and a disabling transition edge (that is, a falling edge) F20. The NMOS transistor 110A (that is, the power switch 110) is turned on in response to the occurrence of each pulse P20. For each pulse P20 of the driving signal S10, the time point when the enabling transition edge R20 occurs, the time point when the disabling transition edge F20 occurs, and the time period between the enabling transition edge R20 and the disabling transition edge F20 are collectively defined as a pulse period 20. The control signal S12 comprises a plurality of pulses P21 (as shown in FIG. 2, the plurality of pulses P21 comprise, for example, four pulses P21(1)-P21(4)), and each pulse P21 has an enabling transition edge (that is, a rising edge) R21 and a disabling transition edge (that is, a falling edge) F21. Each pulse P20 of the driving signal S10 corresponds to one pulse P21 of the control signal S12. According to the embodiment of the present invention, for each pulse P21 of the control signal S12, the enabling transition edge R21 of the pulse P21 occurs in the pulse period 20 of the corresponding pulse P20. Specifically, for each pulse P21 of the control signal S12, the enabling transition edge R21 of the pulse P21 is aligned with the enabling transition edge R20 of the corresponding pulse P20, or occurs in the time period between the enabling transition edge R20 and the disabling transition edge F20 of the corresponding pulse P20. Moreover, for each pulse P21 of the control signal S12, the disabling transition edge F21 of the pulse P21 is aligned with the disabling transition edge F20 of the corresponding pulse P20, or occurs in the time period between the enabling transition edge R20 and the disabling transition edge F20 of the corresponding pulse P20.

The operations of the bias voltage generating circuit 13 and the controller 16 in the embodiment will be explained below by referring to FIGS. 1-2. In the following description, for each pulse P21 of the control signal S12, the enabling transition edge R21 and the disabling transition edge F21 are defined as follows: the enabling transition edge R21 is aligned with the enabling transition edge R20 of the corresponding pulse P20, and the disabling state transition edge F21 occurs in the time period between the enabling state transition edge R20 and the disabling state transition edge F20 of the corresponding pulse P20. Moreover, in the following description, the width of each pulse P21 of the control signal S12 is fixed.

Referring to FIGS. 1 and 2, during the pulse period of each pulse P20 of the driving signal S10, the controller 16 determines whether the output voltage V_{DD} is lower than a lower threshold voltage. For example, during the pulse period 20 of the pulse P20(1), the controller 16 determines whether the output voltage V_{DD} is lower than the lower threshold voltage V_{TH_L}. As shown in FIG. 2, during the pulse period 20 of the pulse P20(1), the output voltage V_{DD} is lower than the lower threshold voltage V_{TH_L}. At this time, the controller 16 enables the control signal S12 so that the control signal S12 has the pulse P21(1). The NMOS transistor 130A is turned on according to the pulse P21(1). In this case, the NMOS transistor 110A and the NMOS transistor 130A are turned on at the same time (that is, the power switch 110 and the switch circuit 135 are turned on at the same time), and a charge current flowing through the diode 131, the auxiliary winding 102, and the NMOS transistor 130A is generated to charge the inductor 133. Thus, the current 1133 of the inductor 133 increases, thereby storing energy in the inductor 133. In response to the disabling transition edge F21 of the pulse P21(1), the switch 130 is turned off. At this time, a discharge current flowing through the diode 132 and the capacitor 134 is generated to discharge the inductor 133, thereby transferring the energy stored in the inductor 133 to the voltage output terminal T11 through the diode 132. As a result, the capacitor 134 is charged. Thus, in response to the disabling transition edge F21 of the pulse P21(1), the current 1133 gradually decreases, and a current 1132 flowing through the diode 132 immediately increases and then gradually decreases. Through charging the capacitor 134, the output voltage V_{DD} gradually increases.

In response to that the controller 16 determines that the output voltage V_{DD} is lower than the lower threshold voltage V_{TH_L} during the pulse period 20 of the pulse P20(1), the controller 16 enables the control signal S12 after the pulse P21(1) to cause the control signal S12 to have the pulse P21(2) corresponding to the pulse P20(2). In the embodiment of the present invention, there is a predetermined period 21 between the disabling transition edge F21 of the pulse P21(1) and the enabling transition edge R21 of the pulse P21(2). The switch 130 is turned on in response to the pulse P21(2). At this time, the inductor 133 is charged again so that the current 1133 of the inductor 133 increases, thereby storing energy in the inductor 133. In response to the disabling transition edge F21 of the pulse P21(2), the switch 130 is turned off. At this time, the inductor 133 is discharged again, thereby transferring the energy stored in the inductor 133 to the voltage output terminal T11 through the diode 132. Accordingly, the capacitor 134 is charged again. Therefore, in response to the disabling transition edge F21 of the pulse P21(2), the current 1133 gradually decreases, and the current 1132 flowing through the diode 132 immediately increases and then gradually decreases. Through charging the capacitor 134 again, the output voltage V_{DD} continues to gradually increase.

In the embodiment of the present invention, the controller 16 determines whether the output voltage V_{DD} is higher than an upper threshold voltage V_{T}H_H in real time. Referring to FIG. 2, at a time point T20, the controller 16 determines that the output voltage V_{DD} is higher than the upper threshold voltage V_{T}H_H. After the predetermined period 21 starting from the pulse P21(2) has elapsed, the controller 16 does not enable the control signal S12 any more, that is, the control signal S12 is at a fixed low voltage level (that is, a disabled level). At this time, the output voltage V_{DD} gradually decreases. Then, the controller 16 still does not enable the control signal S12 until the controller 16 determines that the output voltage V_{DD} is lower than the lower threshold voltage V_{TH_L} during the pulse period 20 of the subsequent pulse P20(5). The controller 16 enables the control signal S12 based on the determination result so that the control signal S12 has the pulse P21(3). The operation of the bias voltage generating circuit 13 in response to the pulse P21(3) is the same as the operation corresponding to the pulse P21(1), and the related description is omitted here.

According to the above description, referring to FIG. 2, the pulses P21(1)-P21(4) of the control signal S12 correspond to the pulses P20(1)-P20(2) and P20(5)-P20(6) of the driving signal S10, that is, the pulses P21(1)-P21(4) are synchronized with the pulses P20(1)-P20(2) and P20(5)-P20(6). Through the determination operation performed by the controller 16 on the output voltage V_{DD}, the controller 16 generates the pulses P21(1)-P21(4) at a non-fixed frequency. As shown in FIG. 2, the time period in which the pulses P21(1) and P21(2) are concentrated is not continuous with the time period in which the pulses P21(3) and P21(4) are concentrated. The time period between the disabling transition edge F21 of the pulse P21(2) and the enabling transition edge R21 of the pulse P21(3) is greater than the predetermined period 21. In the embodiment of FIG. 2, the time period between the disabling transition edge F21 of the pulse P21(2) and the enabling transition edge R21 of the pulse P21(3) is greater than three times the predetermined period 21.

According to the above description, through controlling the bias voltage generating circuit 13 through the control signal S12 by the controller 16, the output voltage V_{DD} of the present invention can be adjusted to a voltage between the lower threshold voltage V_{TH_L} and the upper threshold voltage V_{TH_H}, and the output voltage V_{DD} is not limited to the magnitude of the input voltage V_{IN} and/or output voltage V_{OUT}. In this way, even if the required range of the output voltage V_{OUT} is relatively large, the required output voltage V_{DD} generated by the bias voltage generating circuit 13 can be controlled by controlling or adjusting the pulses of the control signal S12, and the output voltage V_{DD} is not affected by the output voltage V_{OUT}.

In the embodiment, the widths of the pulses P21(1)-P21(4) of the control signal S12 can be determined according to the magnitude of the input voltage V_{IN}. For example, compared with the widths of the pulses P21(1)-P21(4) of the control signal S12 that is presented when the input voltage V_{IN} is greater, the widths of the pulses P21(1)-P21(4) of the control signal S12 are greater when the input voltage V_{IN} is less.

In the above embodiment, the controller 16 determines whether the output voltage V_{DD} is lower than the lower threshold voltage V_{TH_L}, and also determines whether the output voltage V_{DD} is higher than the upper threshold voltage V_{TH_H}. In another embodiment, the controller 16 continuously enables the control signal S12 at a fixed frequency (that is, a pulse repetition frequency) so that the control signal S12 comprises a plurality of pulses, wherein there is a fixed time interval between any two pulses. In this embodiment, the plurality of the control signal S12 correspond to the plurality of pulses of the driving signal S10 respectively, that is, the plurality of pulses of the control signal S12 are synchronized with the plurality of pulses of the driving signal S10. Moreover, compared with the embodiment of FIG. 2, the widths of the plurality of pulses of the s control signal S12 that is continuously enabled in the embodiment are less than the widths of the pulses P21(1)-P21(4) in FIG. 2. In the embodiment, the magnitude of the output voltage V_{DD} is determined by the widths of the plurality of pulses of the control signal S12.

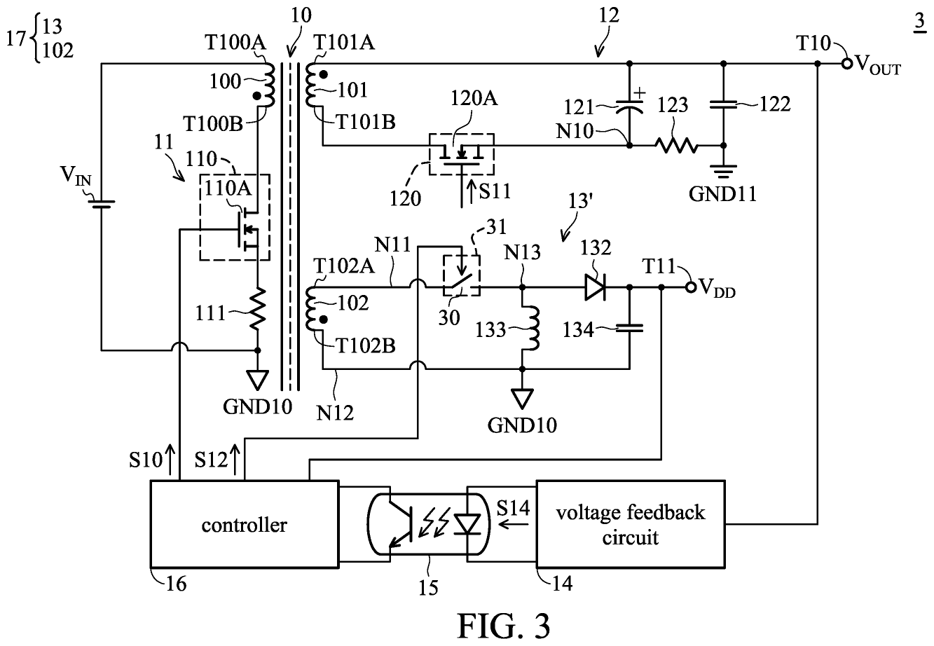

FIG. 3 shows another exemplary embodiment of a power converter. The structure of a power converter shown in in FIG. 3 is substantially the same as the structure of the power converter 1 shown in FIG. 1. The difference between the power converter shown in FIG. 3 and the power converter 1 shown in FIG. 1 is that a bias voltage generating circuit 13′ in the embodiment in FIG. 3 is provided to replace the bias voltage generating circuit 13 in the embodiment in FIG. 1.

Referring to FIG. 3, the bias voltage generating circuit 13′ comprises the diode 132, the inductor 133, and the capacitor 134 shown in FIG. 1, but does not comprise the switch 130 and diode 131 shown in FIG. 1. The bias voltage generating circuit 13′ further comprises a switch 30, and the switch 30 is provided to form a switch circuit 31. The switch 30 is coupled between the first terminal T102A of the auxiliary winding 102 and the node N13. The connection structure of the diode 132, the inductor 133, and the capacitor 134 in the embodiment of FIG. 3 is the same as that in the embodiment of FIG. 1, and the related description is omitted here.

The on/off state of the switch 30 is controlled by the control signal S12. The operation of the controller 16 to generate the control signal S12 is as described in the related paragraphs of the embodiment of FIGS. 1 and 2, and the related description is omitted here. When the switch 30 is turned on in response to a pulse of the control signal S12, the current of the inductor 133 gradually increases to charge the inductor 133, thereby storing energy in the inductor 133. In response to the disabling transition edge of the pulse, the switch 30 is turned off. At this time, the inductor 133 is discharged, and the energy stored in the inductor 133 is transferred to the voltage output terminal T11 through the diode 132 to charge the capacitor 134. Through charging the capacitor 134, the output voltage V_{DD} of the bias voltage generating circuit 13′ gradually increases.

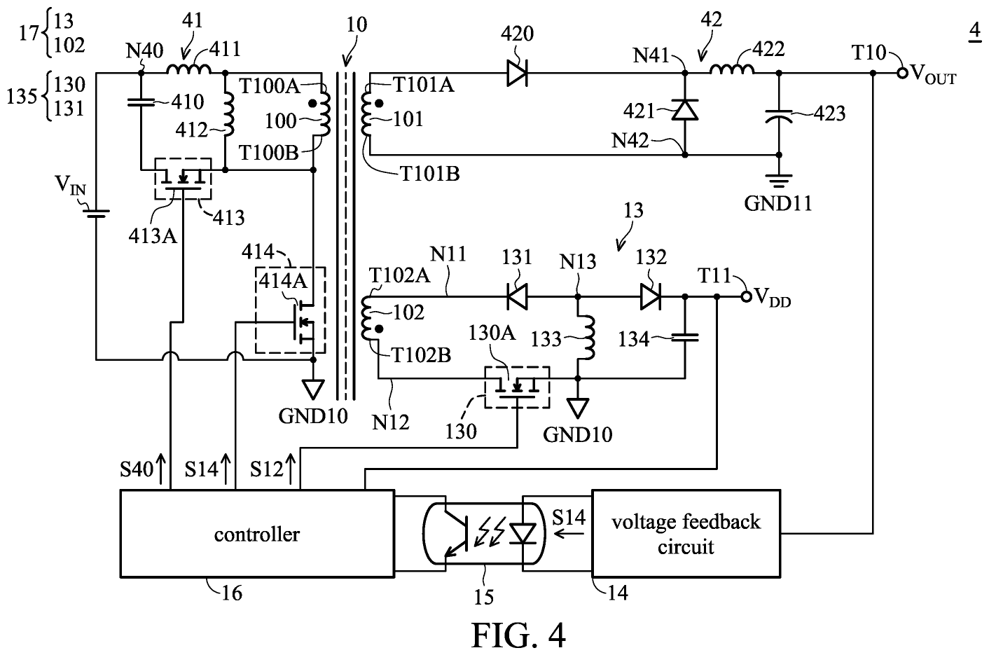

FIG. 4 shows another exemplary embodiment of a power converter. Referring to FIG. 4, a power converter 4 comprises the transformer 10, the bias voltage generating circuit 13, the voltage feedback circuit 14, the optical coupler 15, and the controller 16 that are shown in FIG. 1 and further comprises a primary-side circuit 41 and a secondary-side circuit 42. The circuit structures and operations of the transformer 10, the bias voltage generating circuit 13, the voltage feedback circuit 14, the optical coupler 15, and the controller 16 are as described in the related paragraphs of the embodiment of FIGS. 1 and 2, and the related description is omitted here.

In the embodiment of FIG. 4, according to the circuit architectures of the transformer 10, the primary-side circuit 41, and the secondary-side circuit 42, the power converter 4 operates as a forward power converter. Referring to FIG. 4, the first terminal T100A of the primary winding 100 and the first terminal T101A of the secondary winding 101 are the terminals with the same polarity (that is, the terminals with the same name), and the second terminal T100B of the primary winding 100 and the second terminal T101B of the secondary winding 101 are the terminals with the same polarity.

As shown in FIG. 4, the primary-side circuit 41 comprises a capacitor 410, inductors 411 and 412, and power switches 413 and 414. The primary-side circuit 41 receives the input voltage V_{IN} through a node N40. A first terminal of the capacitor 410 is coupled to a node N40. The inductor 411 is coupled between the node N40 and the first terminal T100A of the primary winding 100. The inductor 412 is coupled between the first terminal T100A and the second terminal T100B of the primary winding 100. The on/off states of the power switches 413 and 414 are controlled by driving signals S40 and S41 respectively. An input terminal of the power switch 413 is coupled to a second terminal of the capacitor 410, an output terminal thereof is coupled to the second terminal T100B of the primary winding 100, and a control terminal thereof receives the driving signal S40. An input terminal of the power switch 414 is coupled to the second terminal T100B of the primary winding 100, an output terminal thereof is coupled to the ground GND10, and a control terminal thereof receives the driving signal S41. The primary-side circuit 41 is controlled by the driving signals S40 and S41 to convert the input voltage V_{IN} into energy, and the energy is stored in the transformer 10. The controller 16 generates the driving signals S40 and S41 according to the feedback signal S14 that indicates the output voltage V_{OUT}. In the embodiment, the power switches 413 and 414 are implemented by N-type transistors 413A and 414A (that is, NMOS transistors) respectively. The input terminal, the control terminal, and the output terminal of the power switch 413 correspond to a drain, a gate, and a source of the NMOS transistor 413A respectively. The input terminal, the control terminal, and the output terminal of the power switch 414 correspond to a drain, a gate, and a source of the NMOS transistor 414A respectively.

The secondary-side circuit 42 comprises diodes 420 and 421, an inductor 422, and a capacitor 423. A positive input terminal (anode) of the diode 420 is coupled to the first terminal T101A of the secondary winding 101, and a negative input terminal (cathode) thereof is coupled to a node N41. A negative input terminal (cathode) of the diode 421 is coupled to the node N41, and a positive input terminal (anode) is coupled to the ground GND11. The inductor 422 is coupled between the node N41 and the voltage output terminal T10. The capacitor 423 is coupled between the voltage output terminal T10 and the ground GND11. In the embodiment, the secondary-side circuit 42 generates the output voltage V_{OUT} at the voltage output terminal T10 according to the energy stored in the transformer 10.

In the above embodiment, the circuit structures of the primary-side circuit 41 and the secondary-side circuit 42 are taken as an exemplary example, and the present invention is not limited thereto. As long as the power converter 4 operates as a forward power converter, the primary-side circuit 41 and the secondary-side circuit 42 may have other circuit structures.

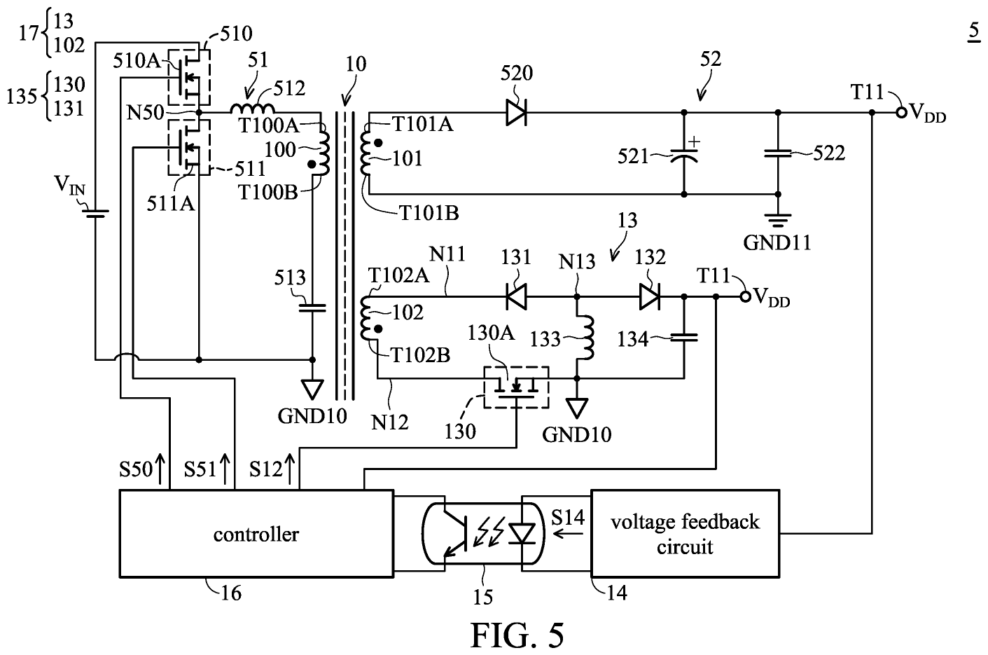

FIG. 5 shows another exemplary embodiment of a power converter. Referring to FIG. 5, a power converter 5 comprises the transformer 10, the bias voltage generating circuit 13, the voltage feedback circuit 14, the optical coupler 15, and the controller 16 that are shown in FIG. 1 and further comprises a primary-side circuit 51 and a secondary-side circuit 52. The circuit structures and operations of the transformer 10, the bias voltage generating circuit 13, the voltage feedback circuit 14, the optical coupler 15, and the controller 16 are described in the related paragraphs of the embodiment of FIGS. 1 and 2, and the related description is omitted here.

In the embodiment of FIG. 5, according to the circuit structures of the transformer 10, the primary-side circuit 51, and the secondary-side circuit 52, the power converter 5 operates as an asynchronous half bridge flyback power converter. Referring to FIG. 5, the first terminal T100A of the primary winding 100 and the second terminal T101B of the secondary winding 101 are the terminals with the same polarity (that is, the terminals with the same name), and the second terminal T100B of the primary winding 100 and the first terminal T101A of the secondary winding 101 are the terminals with same polarity.

As shown in FIG. 5, the primary-side circuit 51 comprises power switches 510 and 511, an inductor 512, and a capacitor 513. The on/off states of the power switches 510 and 511 are controlled by driving signals S50 and S51 respectively. An input terminal of the power switch 510 is coupled to the input voltage V_{IN}, an output terminal thereof is coupled to a node N50, and a control terminal thereof receives the driving signal S50. An input terminal of the power switch 511 is coupled to the node N50, an output terminal thereof is coupled to the ground GND10, and a control terminal thereof receives the driving signal S51. The inductor 512 is coupled between the node N50 and the first terminal T100A of the primary winding 100. The capacitor 513 is coupled between the second terminal T100B of the primary winding 100 and the ground GND10. The primary-side circuit 51 is controlled by the driving signals S50 and S51 to convert the input voltage V_{IN} into energy, and the energy is stored in the transformer 10. The controller 16 generates the driving signals S50 and S51 according to the feedback signal S14 that indicates the output voltage V_{OUT}. In the embodiment, the power switches 510 and 511 are implemented by N-type transistors 510A and 511A (for example, NMOS transistors) respectively. The input terminal, control terminal and output terminal of the power switch 510 correspond to a drain, a gate, and a source of the NMOS transistor 510A respectively. The input terminal, control terminal and output terminal of the power switch 511 correspond to a drain, a gate, and a source of the NMOS transistor 511A respectively.

The secondary-side circuit 52 comprises a diode 520 and capacitors 521 and 522. A positive input terminal (anode) of the diode 520 is coupled to the first terminal T101A of the secondary winding 101, and a negative input terminal (cathode) thereof is coupled to the voltage output terminal T10. Each of the capacitors 521 and 522 is coupled between the voltage output terminal T10 and the ground GND11. In the embodiment, the secondary-side circuit 52 generates the output voltage V_{OUT} at the voltage output terminal T10 according to the energy stored in the transformer 10.

In the above embodiment, the circuit structures of the primary-side circuit 51 and the secondary-side circuit 52 are taken as an exemplary example, and the present invention is not limited thereto. As long as the power converter 5 can operate as an asynchronous half bridge flyback power converter, the primary-side circuit 51 and the secondary-side circuit 52 may have other circuit structures.

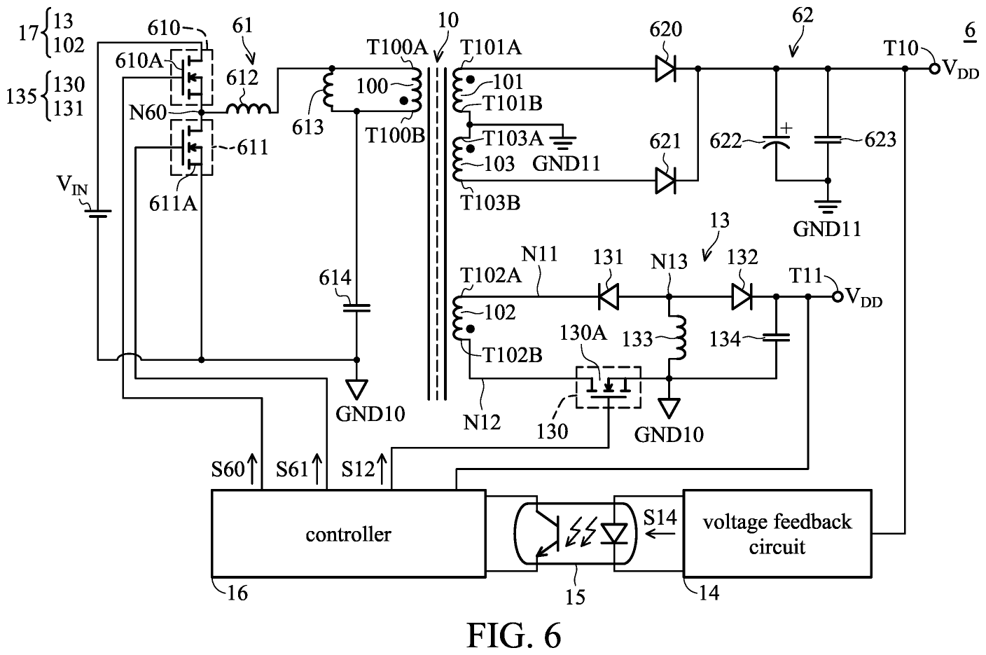

FIG. 6 shows another exemplary embodiment of a power converter. Referring to FIG. 6, a power converter 6 comprises the transformer 10, the bias voltage generating circuit 13, the voltage feedback circuit 14, the optical coupler 15, and the controller 16 that are shown in FIG. 1 and further comprises a primary-side circuit 61 and a secondary-side circuit 62. The circuit structures and operations of the transformer 10, the bias voltage generating circuit 13, the voltage feedback circuit 14, the optical coupler 15, and the controller 16 are described in the related paragraphs of the embodiments of FIGS. 1 and 2, and the related description is omitted here.

In the embodiment of FIG. 6, according to the circuit structures of the transformer 10, the primary-side circuit 61, and the secondary-side circuit 62, the power converter 6 operates as an LLC power converter. Referring to FIG. 6, the first terminal T100A of the primary winding 100 and the second terminal T101B of the secondary winding 101 are the terminals with the same polarity (that is, the terminals with the same name), and the second terminal T100B of the primary winding 100 and the first terminal T101A of the secondary winding 101 are the terminals with the same polarity.

It should be noted that in the embodiment, the transformer 10 further comprises a secondary winding 103. The secondary winding 103 comprises a first terminal T103A and a second terminal T103B. The second terminal T101B of the secondary winding 101 is coupled to the first terminal T103A of the secondary winding 103, and the second terminal T101B and the first terminal T103A are coupled to the ground GND11.

As shown in FIG. 6, the primary-side circuit 61 comprises power switches 610 and 611, a resonant inductor 612, a magnetizing inductor 613, and a resonant capacitor 614. The on/off states of the power switches 610 and 611 are controlled by driving signals S60 and S61 respectively. An input terminal of the power switch 610 is coupled to the input voltage V_{IN}, an output terminal thereof is coupled to a node N60, and a control terminal thereof receives the driving signal S60. An input terminal of the power switch 611 is coupled to the node N60, an output terminal thereof is coupled to the ground GND10, and a control terminal thereof receives the driving signal S61. The resonant inductor 612 is coupled between the node N60 and the first terminal T100A of the primary winding 100. The magnetizing inductor 613 is coupled in parallel with the primary winding 100, that is, the magnetizing inductor 613 is coupled between the first terminal T100A and the second terminal T100B of the primary winding 100. The resonant capacitor 614 is coupled between the second terminal T100B of the primary winding 100 and the ground GND10. The resonant inductor 612, the magnetizing inductor 613, and the resonant capacitor 614 form a resonant tank. The primary-side circuit 61 is controlled by the driving signals S60 and S61 to convert the input voltage V_{IN} to energy, and the energy is stored in the transformer 10. The controller 16 generates the driving signals S60 and S61 according to the feedback signal S14 that indicates the output voltage V_{OUT}. In the embodiment, the power switches 610 and 611 are implemented by N-type transistors 610A and 611A (that is, NMOS transistors) respectively. The input terminal, the control terminal, and the output terminal of the power switch 610 correspond to a drain, a gate, and a source of the NMOS transistor 610A respectively. The input terminal, the control terminal, and the output terminal of the power switch 611 correspond to a drain, a gate, and a source of the NMOS transistor 611A respectively.

The secondary-side circuit 62 comprises diodes 620 and 621 and capacitors 622 and 623. A positive input terminal (anode) of the diode 620 is coupled to the first terminal T101A of the secondary winding 101, and a negative input terminal (cathode) thereof is coupled to the voltage output terminal T10. A positive input terminal (anode) of the diode 621 is coupled to the second terminal T103B of the secondary winding 103, and a negative input terminal (cathode) thereof is coupled to the voltage output terminal T10. Each of the capacitors 622 and 623 is coupled between the voltage output terminal T10 and the ground GND11. In the embodiment, the secondary-side circuit 62 generates the output voltage V_{OUT} at the voltage output terminal T10 according to the energy stored in the transformer 10.

In the above embodiment, the circuit structures of the primary-side circuit 61 and the secondary-side circuit 62 are taken as an exemplary example, and the present invention is not limited thereto. As long as the power converter 6 can operate as an LLC power converter, the primary-side circuit 61 and the secondary-side circuit 62 may have other circuit structures.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bias voltage generator for a power converter, the power converter comprising a transformer, the bias voltage generator comprising:
an auxiliary winding;
a switch circuit coupled to the auxiliary winding at a first node and controlled by a control signal;
an inductor comprising a first terminal coupled to the switch circuit at a second node and a second terminal coupled to a ground;
a first diode comprising an anode coupled to the second node and a cathode coupled to a voltage output terminal; and
a capacitor coupled between the voltage output terminal and the ground,
wherein in response to that the switch circuit is turned on, the inductor is charged by a charging current flowing through the switch circuit and the auxiliary winding,
wherein in response to that the switch circuit is turned off, the inductor is discharged through a discharge current flowing through the first diode and the capacitor, and
wherein an output voltage is generated at the voltage output terminal, and the output voltage changes according to the control signal.

2. The bias voltage generator as claimed in claim 1, wherein the control signal comprises a plurality of pulses that are generated at a pulse repetition frequency, each of the plurality of pulse has a pulse width, and the output voltage changes according to the pulse widths of the plurality of pulses.

3. The bias voltage generator as claimed in claim 1, wherein the control signal comprises a plurality of pulses, and the output voltage increases in response to the pulses.

4. The bias voltage generator as claimed in claim 3, wherein the plurality of pulses of the control signal are concentrated in a first period and a second period that are not continuous in time.

5. The bias voltage generator as claimed in claim 1, wherein the auxiliary winding comprises a first terminal coupled to the first node and a second terminal coupled to a third node, and the switch circuit comprises:
a second diode having a cathode coupled to the first node and an anode coupled to the second node; and
a switch coupled between the third node and the ground and controlled by the control signal.

6. The bias voltage generator as claimed in claim 1, wherein the auxiliary winding comprises a first terminal coupled to the first node and a second terminal coupled to the ground, and the switch circuit comprises:
a switch coupled between the first node and the second node and is controlled by the control signal.

7. The bias voltage generator as claimed in claim 1, wherein the auxiliary winding is part of the transformer.

8. A power converter comprises:
a transformer comprising a primary winding, a secondary winding, and an auxiliary winding, wherein the auxiliary winding comprises a first terminal and a second terminal;
a primary-side circuit, coupled to the primary winding, receiving an input voltage and a driving signal, wherein the primary-side circuit comprises a first switch coupled to the primary winding, the first switch is controlled by the driving signal to convert the input voltage to energy, and the energy is stored in the transformer;
a secondary-side circuit, coupled to the secondary winding, generating a first output voltage at a first voltage output terminal according to the energy stored in the transformer;
a controller generating the driving signal according to the first output voltage and further generating a control signal; and
a bias voltage generating circuit coupled to the first terminal and the second terminal of the auxiliary winding and controlled by the control signal to generate a second voltage at a second voltage output terminal according to the energy stored in the transformer,
wherein the bias voltage generating circuit adjusts the second output voltage according to the control signal, and the second output voltage is provided to the controller as a supply voltage of the controller, and
wherein the bias voltage generating circuit comprises:
a switch circuit coupled to the first terminal of the auxiliary winding at a first node and controlled by the control signal;
an inductor comprising a first terminal coupled to the switch circuit at a second node and a second terminal coupled to a ground;
a first diode comprising an anode coupled to the second node and a cathode coupled to the second voltage output terminal; and
a capacitor coupled between the second voltage output terminal and the ground,
wherein in response to that the first switch and the switch circuit are turned on at the same time, the inductor is charged by a charging current flowing through the switch circuit and the auxiliary winding, and
wherein in response to that the switch circuit is turned off, the inductor is discharged through a discharge current flowing through the first diode and the capacitor.

9. The power converter as claimed in claim 8, wherein the control signal comprises a plurality of first pulses that are generated at a pulse repetition frequency, each of the plurality of first pulses has a first pulse width, and the output voltage changes based on the first pulse widths of the plurality of first pulses.

10. The power converter as claimed in claim 9, wherein the control signal changes the first pulse widths of the plurality of first pulses according to the input voltage.

11. The power converter as claimed in claim 9, wherein the control signal changes the first pulse widths of the plurality of first pulses according to the second output voltage.

12. The power converter as claimed in claim 9, wherein:
the driving signal comprises a plurality of second pulses, and
an enabling transition edge of each of the plurality of first pulses occurs in a pulse period of one of the plurality of second pulses.

13. The power converter as claimed in claim 8, wherein:
the driving signal comprises a plurality of first pulses,
the controller determines whether the second output voltage is lower than a threshold voltage during a pulse period of one of the plurality of first pulses, and
in response to that the controller determines that the second output voltage is lower than the lower threshold voltage during the pulse period of one of the plurality of first pulses, the controller causes the control signal to have a second pulse so that the bias voltage generating circuit increases the second output voltage according to the second pulse of the control signal.

14. The power converter as claimed in claim 13, wherein an enabling transition edge of the second pulse of the control signal occurs in a pulse period of the corresponding first pulse.

15. The power converter as claimed in claim 13, wherein:
the controller further determines whether the second output voltage is higher than an upper threshold voltage, and
in response to that the controller determines that the second output voltage is higher than the upper threshold voltage, the controller causes the control signal at a fixed voltage level.

16. The power converter as claimed in claim 1, wherein the second terminal of the auxiliary winding is coupled to a third node, and the switch circuit comprises:
a second diode comprises a cathode coupled to the first node and an anode coupled to the second node;
a second switch coupled between the third node and a ground and controlled by the control signal.

17. The power converter as claimed in claim 8, wherein the second terminal of the auxiliary winding is coupled to the ground, and the switch circuit comprises:
a second switch coupled between the first node and the second node and controlled by the control signal.

18. The power converter as claimed in claim 8, wherein the power converter is a flyback power converter, a forward power converter, an asymmetric half bridge flyback power converter, or an LLC power converter.

19. A bias voltage generating method for a power converter, the power converter comprising a transformer, a primary-side circuit, a controller, and a bias voltage generating circuit, the transformer comprising a primary winding and an auxiliary winding, the primary-side circuit being coupled to the primary winding, the controller comprising a first switch, the bias voltage generating circuit being coupled to the auxiliary winding, the bias voltage generating circuit comprising a switch circuit, an inductor, a first diode, and a capacitor, the bias voltage generating method comprising:
by the controller, generating a driving signal to control the first switch and further generating a control signal to control the switch circuit;
by the primary-side circuit, converting an input voltage to energy according to the driving signal, wherein the energy is stored in the transformer;
generating an output voltage by charging and discharging the inductor, comprising:
through the driving signal and the control signal, turning on the first switch and the switch circuit at the same time to generate a charging current flowing through the switch circuit and the auxiliary winding according to the energy stored in the transformer to charge the inductor; and
through the control signal, turning off the switch circuit to generate a discharge current flowing through the first diode and the capacitor to discharge the inductor;
providing the output voltage to the controller as a supply voltage of the controller; and
changing the control signal according to the input voltage or the output voltage, thereby adjusting the output voltage.

20. The bias voltage generating method as claimed in claim 19, wherein:
the control signal comprises a plurality of pulses that are generated at a pulse repetition frequency, and each pulse has a pulse width,
changing the control signal according to the input voltage or the output voltage comprises:
changing the pulse widths of the plurality of pulses according to the input voltage or the output voltage.

21. The bias voltage generating method as claimed in claim 19, wherein:
the driving signal comprises a plurality of first pulses, and
changing the control signal according to the input voltage or the output voltage comprises:
determining whether the output voltage is lower than a lower threshold voltage during a pulse period of one of the plurality of first pulses;
determining whether the output voltage is higher than an upper threshold voltage;
in response to that the output voltage is lower than the lower threshold voltage during the pulse period of one of the plurality of first pulses, causing the control signal to have a second pulse so that the bias voltage generating circuit increases the output voltage according to the second pulse, and
in response to that the output voltage is higher than the upper threshold voltage, casing the control signal to be at a fixed voltage level.

22. The bias voltage generating method as claimed in claim 19, wherein the power converter is a flyback power converter, a forward power converter, an asymmetric half bridge flyback power converter, or an LLC power converter.
